(19) United States
(12) Patent Application Publication
(10) Pub. No.: US 2022/0000287 A1
(43) Pub. Date: Jan. 6, 2022

(54) ROTATABLE PICTURE HANGER

(71) Applicant: Levitate Innovations Inc., Los Angeles, CA (US)

(72) Inventor: Moshe LEVIS, Los Angeles, CA (US)

(73) Assignee: Levitate Innovations Inc., Los Angeles, CA (US)

(21) Appl. No.: 17/294,200

(22) PCT Filed: Aug. 15, 2019
(86) PCT No.: PCT/US2019/046721

§ 371 Date: May 14, 2021

Related U.S. Application Data
(60) Provisional application No. 62/768,440, filed on Nov. 16, 2018.

(51) Int. Cl. A47G 1/16

(52) U.S. Cl. CPC A47G 1/166; A47G 1/175

(57) ABSTRACT

A rotatable hanger device comprises: a mounting part comprising a front and back, the first side of the back fastenable to a first surface and the second side of the back positioned adjacent to the first side, and an arm positioned between the back and front, and connecting the back and front; and a housing part comprising a front and back, the first side of the back fastenable to a second surface and the second side of the back positioned adjacent to the first side, the front comprising a cut-out along an edge, and a wall connecting the housing back and front; wherein, the cut-out is sized and shaped relative to a size and shape of the arm, and wherein, the mounting and housing parts interlock such that the mounting front rests between the first side of the housing front and the second side of the housing back.

### CROSS-REFERENCE TO RELATED APPLICATIONS

This patent application is a National Phase Application of PCT International Application No. PCT/US2019/046721, International Filing Date Aug. 15, 2019, claiming the benefit of U.S. Provisional Patent Application No. 62/768,440, filed Nov. 16, 2018 which are all hereby incorporated by reference.

### FIELD OF THE INVENTION

The present invention is in the field of mounting devices. In particular, the present invention is directed to a rotatable picture hanger.

### BACKGROUND OF THE INVENTION

The current common picture hanger is used daily, usually to hang pictures and other works of art. The most common picture hanger is simply a nail, screw, hook, or the like, thrust into a wall surface. Pictures that are hung on the nail usually have some wire or other needed attachment, meaning the nail alone is not enough for hanging a picture securely. However, using a nail or other similar hanging device typically can cause the picture to hang at an angle. A user typically needs to take several measurements when hammering a nail to a wall and attach hooks and/or wire to a picture frame. Furthermore, finding a centerline and correct height can be unnecessarily difficult since the nail often does not align with the exact top and/or center of the picture or picture frame. For example, many picture frames include one or more triangular loops fastened to the back which accept a nail, screw, or hook. Placement of the nail such that it properly aligns with the loop and places the picture in the right location and/or orientation can be exceedingly challenging and unnecessarily time-consuming. Moreover, when taking the picture and nail off the wall surface, a hole is left exposed in the damaged wall.

Other hangers attempt to solve the above problems by mounting hooks and other locking mechanisms on to a wall surface, for example, using stretch-releasable adhesive tape. However, adjustment is still difficult and time consuming regardless. For example, if the owner of the picture desires to re-hang a landscape-oriented picture in a portrait orientation, or vice versa, the picture typically requires new measuring and hanging.

Additionally, typical hangers offer their own unique problems. First, the hook or other fastener is typically exposed or partially exposed to the naked eye, which lowers the overall esthetics. Second, due to the protrusion of such hangers from the wall or surface, the hung picture is typically tilted downwards rather than hanging parallel to the wall or surface, which would offer the maximum viewing experience.

Another common hanger is a fastener type hanger. Although it may address the tilting of the picture and the exposure of the hook to some extent, it presents further problems: A. These hangers are not reusable, which demands the user spending more money and creating more trash, if and when replacements are needed. B. Depending on the weight of the picture, a user must use a minimum of two pairs of these hangers. C. These hangers must be replaced both on the wall and on the picture, if a user desires to hang a different size picture. D. For a user to hang a picture straight (usually the desired orientation), that user typically needs the help of another. E. If, at the end of hanging a picture, the picture is not leveled properly, the user needs to replace all used hangers and try again. These inconveniences and esthetic problems are not solved even with hangers that offer rotation capabilities for leveling pictures after hanging them.

Additionally, since these hangers are typically placed on the frame of a picture (e.g., top, bottom, left or right) the user needs to install several sections of said hanger on a single picture to be able and change the orientation from horizontal to vertical and vice versa. Furthermore, such hangers have protruding teeth which limit the angles possible for rotation. Another problem it presents is that the hanger does not allow a 360-degree rotation. Finally, the installing of such hangers on a wall surface and picture frame are overly complicated and time consuming.

It is desirable to have hangers that leave no damage on a wall surface, after removal, and which eliminate the need for using any kind of tools. In addition, there is a need for solving the inconvenience of making sure the picture is leveled prior to hanging it, and readjusting the level after hanging. Hanging a picture many times comes at a cost in both time and money. Accordingly, what is needed is a picture hanger that solves all the aforementioned problems, an provides a circular hanger which is able to be rotated 360 degrees after hanging a picture on a wall surface without any tools.

### BRIEF SUMMARY OF THE INVENTION

Embodiments of the invention provide a rotatable hanger device, including: a mounting part, including: a mounting front and a mounting back, each of the mounting front and the mounting back having a first side and a second side, the first side of the mounting back configured to be fastenable to a first surface and the second side of the mounting back positioned adjacent to the first side of the mounting front; and a connecting arm, in which the connecting arm is positioned between the mounting back and the mounting front, and connects the second side of the mounting back and the first side of the mounting front; and a housing part including: a housing front and a housing back, each of the housing front and the housing back having a first side and a second side, the first side of the housing back configured to be fastenable to a second surface and the second side of the housing back positioned adjacent to the first side of the housing front; in which the housing front comprises a cut-out along an edge of the housing front; and a wall connecting the housing back and the housing front; in which, the cut-out is sized and shaped relative to a size and shape of the connecting arm; and in which, the mounting part and the housing part are configured to interlock via insertion of a portion of the connecting arm into the cut-out such that at least part of the mounting front rests between the first side of the housing front and the second side of the housing back.

In some embodiments, the first surface is a surface of a picture frame. In some embodiments, the first surface is a surface of an electronic device comprising a display. In some embodiments, the second surface is a wall. In some embodiments, the second surface is an interior surface of a vehicle. In some embodiments, the device further includes a mount-fastening means, in which the first side of the mounting back is configured to be fastenable to the first surface by the mount-fastening means. In some embodiments, the device further includes a housing-fastening means, in which the first side of the housing back is configured to be fastenable to the second surface by the housing-fastening means. In some embodiments, the connecting arm has a cylindrical cross-section and the cut-out has a corresponding u-shape. In some embodiments, the connecting arm has a polygonal cross-section and the cut-out has a corresponding polygonal shape.

Methods according to embodiments of the above devices may be provided. These and other aspects, features and advantages will be understood with reference to the following description of certain embodiments of the invention.

Embodiments of the invention provide a rotatable picture hanger that enables the user to hang a picture on a wall in a significantly short period of time, e.g., about five seconds. The rotatable picture hanger may include a mounting section and a housing section. The mounting section and the housing section may combine to attach a picture to a wall without using any tools, measuring any distances, or being precise. Furthermore, the user can adjust the angle of the picture, if desired, after hanging it.

In some embodiments, the mounting section may be attached to the back of the picture and the housing section may be attached to the wall or other surface, for example, using stretch-releasable adhesive tapes. As described herein, the house section comprising a pocket which is configured to receive a portion of the mounting section, by which the two parts are removably attached. The hanging operation is complete once the portion of the mounting section is inserted or slid, e.g., from above, into the housing section. The user then, may easily rotate the picture to any desired angle (e.g., making sure the picture is straight and level, etc.).

In some embodiments, the rotatable picture hanger may be a reusable picture hanger system that attaches both to a wall surface and the back of a picture. In some embodiments, the hanger system may be fastened to the back of a picture having a flat surface. In other embodiments, the hanger system may be attached to a wiring or suspension system affixed to the back of a picture (or picture frame), for example, when the back of the picture is not a flat surface or is not sufficiently ridged to support the hanger system directly.

In some embodiments, the rotatable picture hanger may be comprised of two primary or main sections or parts, including a mounting section or part and a housing section or part. Each part consists of a generally flat side, which, in some embodiments, may be shaped like a large disc. On the back of each large disc of each section, may be mounted stretch-releasable adhesive tapes which may be easily unpeeled and attached to both the back of a picture and a wall surface, respectively. In this embodiment, the duration of the whole operation (e.g., the hanging and leveling of a picture) should take approximately five seconds, which is a feature prior art picture hanging systems cannot offer.

As mentioned above, in some embodiments, the rotatable picture hanger may include a mounting section or part and a housing section part. In some embodiments, the mounting section may be constructed using a large disc as a first side, which purpose is to be attached to a back of a picture or other object having a generally flat surface, a smaller disc on a second side, which purpose is to slide into the housing section or part, as described herein, and a connecting cylinder therebetween. Once the smaller disc rests in the housing section or part, the hanging operation is complete.

In some embodiments, the housing section or part may be constructed using a large disc as a first side, which purpose is to be attached to a wall or other generally flat surface, and a second side including a U-shaped surface (e.g., a surface with a U-shaped cut-out), which purpose is to secure the mounting section or part in place. In some embodiments, the rotatable picture hanger does not require any teeth and as a result, a user can rotate the picture after it is hung, to any desired angle. In some embodiments, the rotatable picture hanger may include teeth to enable rotation at predefined degrees commensurate with the teeth, while still enabling full 360 degree rotation.

In some embodiments, the sections or parts of the rotatable picture hanger may be initially connected so as to indicate to a user the relationship and fit of the two parts. To hang a picture on a wall, a user simply needs to peel off the protective coatings of the tapes from both parts, affix the connected parts, with the mounting part facing the back of a picture, to its center, while keeping the housing part upright. In some embodiments the housing part may include a marker or other indicator, indicating when the housing section is pointing upwards. Once the connected parts are affixed to the picture, the user may affix the picture with the rotatable picture hanger on to the wall or other surface, at the desired location. This will complete the hanging of the picture. If leveling is needed, the user can tilt or rotate the picture left or right with minimal effort. Of course, in other embodiments the hanger can be affix first to a wall or other surface and then a picture (or other object, e.g., an electronic device such as a monitor or mobile device) may be affixed to the hanger. In yet other embodiments, the house part and the mounting part may be separately affixed to respective surfaces and then the two parts may be joined or connected as described herein.

If and when a user wishes to replace the picture already hung, e.g., with a smaller or larger picture, the user may simply detach the mounting section from current hung picture and attach it to a new picture. The user may then slide the mounting section into the housing section and the replacement job is done. No need for brand new hangers or wasting precious time.

Systems and methods according to embodiments of the above may also be provided. These and other aspects, features, and advantages will be understood with reference to the following description of certain embodiments of the invention.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1 is a perspective exploded view of the rotatable picture hanger along with stretch-releasable adhesive tapes according to embodiments of the invention;

FIG. 2 shows a front view of the mounting part according to embodiments of the invention;

FIG. 2a shows a side view of the mounting part according to embodiments of the invention;

FIG. 2b shows a perspective view of the mounting part according to embodiments of the invention;

FIG. 3 shows a front view of the housing part according to embodiments of the invention;

FIG. 3a shows a top view of the housing part according to embodiments of the invention;

FIG. 3b shows a side view of the housing part according to embodiments of the invention;

FIG. 3c shows a perspective view of the housing part according to embodiments of the invention;

FIG. 3d shows a perspective view of the back of the housing part according to embodiments of the invention;

FIG. 4 is a perspective view that illustrates the way both sections may be assembled according to embodiments of the invention; and

FIG. 5 is a perspective exploded view of the rotatable picture hanger along with stretch-releasable adhesive tapes, shown between a picture and a surface according to embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will be apparent to one skilled in the art that the present invention may be practiced without the specific details presented herein. Furthermore, well known features may be omitted or simplified in order not to obscure the present invention.

Hanging a picture (or other object) on a wall is typically time consuming. It can be an annoying and onerous process to go through to make sure the pictures are secured on the wall, leveled properly, esthetically fitting in the room, and not damaging the wall for any reason. Many current solutions require hammering nails into a wall, and often require the help of another person and a leveling tool to ensure pictures are hung level. If a picture is hung incorrectly or crookedly, the use often has to dispose of the hangers and replace them with new ones. This wastes both time and money.

Accordingly, embodiments of the invention enable hanging a picture on the wall in just a few seconds, with the ability to level the picture, post-hanging. Furthermore, embodiments of the invention require no tools or extra help from a second person. Additionally, embodiments of the invention prevent pictures from tilting downwards and avoid the need to see a nail or hook above the hung picture.

Embodiments of the invention provide a rotatable hanger in a circular shape, as described herein. Of course, other shapes are also contemplated according to various embodiments of the invention.

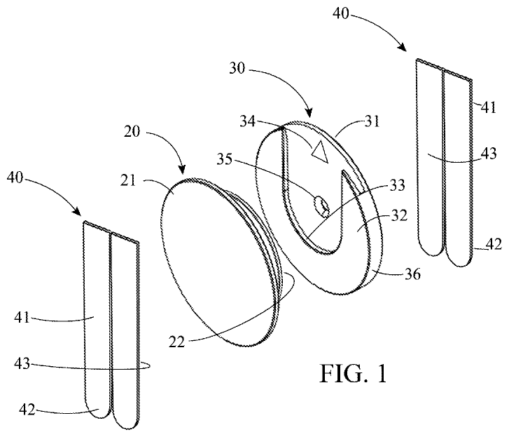

FIG. 1 is a perspective exploded view of the entire rotatable picture hanger, before assembly, according to some embodiments of the invention. It shows the order in which the parts connect, between a picture (or other hangable object) and a surface (e.g., a wall). In some embodiments, one side 43 of a pair of stretch-releasable tapes 40 attaches to the back 21 of the mounting part 20. Another pair of stretch-releasable tapes 40, 43 attaches to the back 31 of the housing part 30. As described herein, mounting part 20 may then be placed in or otherwise connected with the housing part 30.

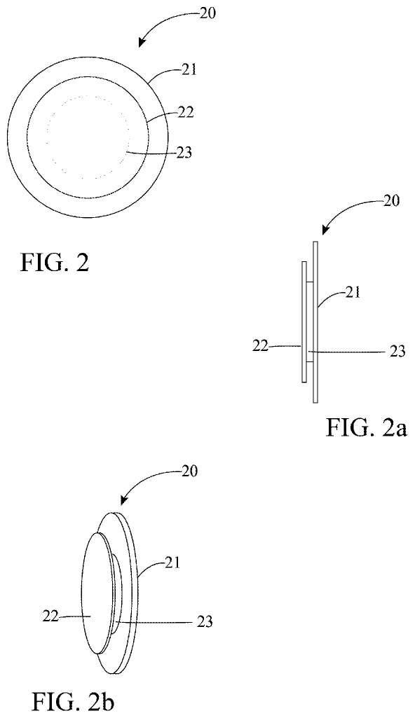

FIG. 2 shows the front view of the mounting part 20, which, according to some embodiments of the invention, is constructed from a mounting back 21, a mounting front 22, and a connecting arm 23. Of course, it will be clear to those skilled in the art that in various embodiments, mounting back 21, mounting front 22, and/or connecting arm 23 may be one or more of a variety of different shapes and sizes, provided they form the basic structure and provide the same or similar overall functionality of embodiments of the invention.

For example, in some embodiments, mounting back 21, mounting front 22, and/or connecting arm 23 may be provided as a large disc 21, a smaller disc 22 and/or a connecting cylinder 23, respectively. Similarly, in some embodiments, mounting back 21 may be provided in the shape of a square, rectangle, triangle, oval, etc., while still providing a flat surface to mount against a picture or other object. Various shapes may, in some embodiments, increase the attachment surface which may increase the overall weight capacity of the hanger. Likewise, in some embodiments, mounting front 22 may be provided in the shape of an oval or any shape (e.g., any polygon) that does not inhibit or materially inhibit rotation of mounting part 20 when connected to housing part 30. Additionally, in some embodiments, connecting arm 23 may have flat or curved sides or edges, etc., provided connecting arm 23 is configured to facilitate insertion of mounting front 22 into, and connection with, housing part 30.

FIG. 2a is a side view of FIG. 2, and shows how mounting back 21, mounting front 22, and connecting arm 23 may be connected according to some embodiments of the invention to form mounting part 20.

FIG. 2b is a perspective view of FIG. 2 and FIG. 2a, and shows how mounting back 21, mounting front 22, and connecting arm 23 may be connected according to some embodiments of the invention to form mounting part 20.

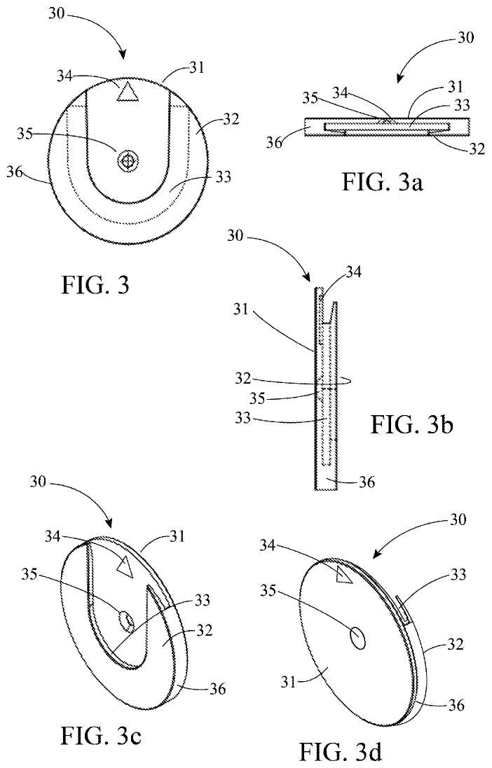

FIG. 3 shows a front view of the housing part 30, which, according to embodiments of the invention, is constructed from a housing back 31, a housing front 32, and a wall 36 connecting the housing back 31 and the housing front 32. Of course, it will be clear to those skilled in the art that in various embodiments, housing back 31 and/or housing front 32, may be one or more of a variety of different shapes and sizes, provided they form the basic structure and provide the same or similar overall functionality of embodiments of the invention.

For example, in some embodiments, housing back 31 and/or housing front 32 may be provided as large disc 31 and U-shaped front 32, respectively. Similarly, in some embodiments, housing back 31 may be provided in the shape of a square, rectangle, triangle, oval, etc., while still providing a flat surface to mount against a picture or other object. Likewise, in some embodiments, housing front 32 may be provided in the shape of V, square, or any other shape (e.g., any polygon) that does not inhibit or materially inhibit mounting part 20 from being connected to housing part 30. For example, in some embodiments housing front 32 may be shaped and dimensioned commensurate with the shape of connecting arm 23 such that housing front 32 is configured to receive or partially receive the cross-section of connecting arm 23 therein while mounting front 22 rests and/or is positioned between or partially between housing front 32 and housing back 31.

Additionally, in some embodiments, wall 36 may be contiguous while in other embodiments wall 36 may be segmented. In some embodiments, wall 36 is sized and dimensioned such that it is configured to hold housing front 32 and housing back 31 sufficiently apart to accept mounting front 22 and sufficiently close to provide rigidity and stability to the connection of mounting part 20 and housing part 30.

In some embodiments, the housing front 32 (e.g., U-shaped front 32) and housing back 31 combine with wall 36 to create or form a pocket 33 that contains or receives at least part of mounting front 22 (e.g., smaller disc 22) of the mounting part 20. In some embodiments, on the front of the large disc 31 may be a marker 34 which may be, for example, in the shape of a triangle or arrow, and which may provide for proper orientation of housing part 30. In some embodiments, housing back 31 may include one or more securing holes 35 for a screw installment, if desired, e.g., in addition to or in place of the stretch-releasable tapes 40.

FIG. 3a is a top view of FIG. 3, in which the pocket 33 formed by the housing front 32 (e.g., U-shaped front 32), housing back 31, and wall 36 can be seen more clearly.

FIG. 3b is a side view of FIG. 3, in which housing back 30 can be seen with pocket 33 (in dashed lines) formed by the housing front 32 (e.g., U-shaped front 32), housing back 31, and wall 36.

FIG. 3c and FIG. 3d are front and back perspective views of FIG. 3, respectively, according to some embodiments of the invention.

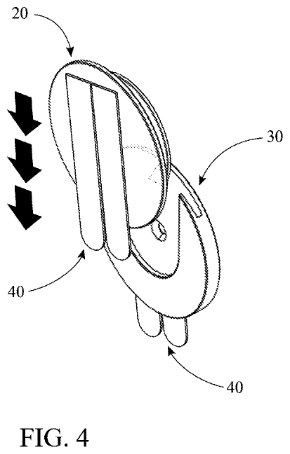

FIG. 4 is a perspective view that illustrates how to assemble and connect the mounting part 20 (with the attached stretch-releasable tapes 40 pre-attached) to the housing part 30 (which includes the stretch-releasable tapes 40 pre-attached as well), according to embodiments of the invention. The arrows indicate the direction in which mounting part 20 is to be inserted (e.g., from above the housing part 30) into pocket 33 in order for the mounting part 20 to rest securely in housing part 30. In some embodiments, once the mounting part 20, when attached to the back of a picture or other object, e.g., using one side 41 of the stretch-releasable tapes 40, is secured in the housing part 30, and part 30 is attached to a wall or other surface, e.g., using the other side 41 (see FIG. 1) of the stretch-releasable tapes 40, the hanging operation is complete.

In some embodiments, housing part 30 may act as a receiver of mounting part 20 and mounting part 20 may act as the interactive element that allows the user to both secure the picture or object to a surface and to level the picture or object after hanging it, e.g., by rotating or pivoting the picture or object about the connecting arm 23 and mounting front 22 within housing part 30.

In some embodiments, housing part 30 may include a gap/pocket 33 that is precisely measured and configured to receive at least part of a cross-section of the connecting arm 23 in the opening of the housing front 32 and receive at least part of mounting front within pocket 33, as described herein. This may allow the mounting part 20 to slide quickly and securely, but also rotatably, into housing part 30. In some embodiments, the rotatable picture hanger has a pocket 33 that is large enough to fit the smaller disc 22, of the mounting part 20 within the housing part 30, yet small enough to stop the mounting part 20 from rotating on its own due, for example due to possible uneven weight distribution caused by not placing the mounting part 20 exactly in the center of the back of a picture or object. Accordingly, in some embodiments, the insides of pocket 33 may provide sufficient friction and/or grip with respect to mounting part 20 such that the picture or object does not rotate on its own, yet enough give to be rotated manually, when desired.

In some embodiments, the inside of pocket 33 (e.g., within the opening of housing front 32 and/or within the inside of wall 36) may be generally smooth so as to allow for smooth rotation of mounting part 20 within housing part 30. In some embodiments, a plurality of teeth or other protrusions may be included in the housing part 30 and/or on the mounting part 20, e.g., to act as incremental steps or stoppers which let a user rotate the picture to a desired angle commensurate with the teeth or protrusions. In some embodiments, inclusion of teeth may make it harder to rotate manually that with a smooth interior pocket/wall, but may provide additional control of rotation. In such embodiments, for example, a user would typically have to lift the picture or object slightly, rotate it, and then reinsert it into place. In some embodiments, a removable insert (not shown) with preformed teeth and/or other protrusions may be provided, e.g., to provide additional resistance from unwanted rotation and/or to temporarily lock the picture or object in a particular orientation.

In some embodiments, the rotatable picture hanger may be made out of recyclable plastic. In some embodiments, the rotatable picture hanger may be made out of different woods, metals, plastics, etc., or a combination thereof.

In some embodiments, the rotatable picture hanger may be reusable. As it is a system that attaches both to a wall or surface and to the back of a picture or object, the back of the picture or object should generally be a flat surface, so the adhesive, e.g., a stretch-releasable tape 40, attached to it can be as effective as possible. Of course, those skilled in the art will recognize that in various embodiments, the backs of mounting part 20 and/or housing part 30 may be custom formed to match the curve and/or shape of any surface. For example, house part 30 may be provided with a curved back to accommodate mounting on a similarly curved column. Likewise, mounting part 20 may be provided with a curved back to accommodate mounting on a similarly curved device back (e.g., a mobile device with a curved back rather than a flat back).

As described herein, the rotatable picture hanger is a combination of two parts, 20 and 30, that include a mounting part 20 and a housing part 30. In some embodiments, on the large discs 21 and 31 may be attached stretch-releasable adhesive tapes 40 which are easily peeled and ready to be used. In other embodiments, various, permanent, impermanent and/or removable fasteners may be employed in place of or in addition to stretch-releasable adhesive tapes 40. For example, hook and loop fasteners, tapes, glues, tacks, adhesives, cements, buttons, magnets, bonds, claps, hooks, screws, nails, suction cups, etc. and/or any combination thereof, may likewise be employed. In some embodiments, on the mounting section 20, these tapes or other fasteners may secure the picture or object to the mounting part 20 and prevent the picture from falling. On the housing part 30, these tapes or other fasteners may secure the housing part 30 to the wall or any other surface, provided the added weight of the picture, once mounted, does not pull the housing section 30 off the wall and, for example, cause the system 20, 30 and 40 to fall altogether.

In some embodiments, the rotatable picture hanger is designed to make the hanging of a picture quick and easy with no extra tools or effort. A properly hung picture is a leveled picture or one oriented in the desired orientation.

As mentioned above, in some embodiments, the hanger system includes a mounting part 20 and a housing part 30. In some embodiments, the mounting part 20 may be built from three extruded circles. A large disc 21, acts as the flat surface of the mounting part 20 and is attachable, using stretch-releasable tapes 40, to a flat back surface of a picture, a connecting cylinder 23 that is extruded from the large disc 21 and a smaller disc 22, which purpose is to slide into the housing part 30 as described herein. Once the smaller disc 22 rests, hands-free, in the housing part 30, the hanging operation is complete.

In some embodiments, the housing part 30 may be built from a large disc 31, which act as the flat surface of the housing part 30 and is attachable, using stretch-releasable tapes 40, to a wall surface, a U-shaped (or other cut-out shaped) front 32, which purpose is to hold the smaller disc 22 of the mounting part 20 and a wall 36 that connects the two together and form a pocket 33. In some embodiments, one or more holes 35 may be provided, e.g., in the center or evenly distributed, to provide extra security when needed or desired. Furthermore, in some embodiments one or more holes 35 may be provided in the mounting part 20 and used similarly to those described with regard to housing part 30, e.g., for extra security.

In some embodiments, the sections of the rotatable picture hanger be provided in a connected state, e.g., with the mounting part 20 contained in the housing section 30. In such embodiments, to hang a picture on the wall, a user simply needs to peel off the protective coating 41 of the stretch-releasable tapes 40 from both parts 20 and 30, push the connected sections (e.g., mounting part 20 towards the center of the back of a picture or center mass of an object), while keeping the marker 34 of the housing section pointing upwards. Then, the user may push the picture together with the rotatable picture hanger onto the wall or surface, at the desired location, completing the hanging of the picture. If leveling is needed, the user can tilt or rotate the picture or object to the left or right with no or minimal effort.

In some embodiments, as described herein, the rotatable picture hanger may be reusable and universal, such that if and when a user wishes to replace the picture already hung, e.g., with a smaller or larger picture, the user simply detaches the mounting part 20 from the current hung picture by pulling the bottom 42 of the stretch-releasable tapes downwards, while pressing the small disc 22. The user then replaces the stretch-releasable tapes 40, peels of the protective coating 41 and attaches the large disc 21 to the center on the back of a new picture (or other object). The user then slides the mounting part 20 into the housing part 30 and the replacement job is done. In some embodiments, if a user does not want to detach the mounting part 20 from the picture, the user can purchase a new mounting part 20 separately or otherwise replace one part of the In some embodiments, the rotatable picture hanger may be magnetized such that the parts 20 and 30 of the hanger attract to each other and hold them tighter, e.g., so as to increase the weight capacity of the hanger and/or to provide additional friction to prevent unwanted rotation.

In some embodiments, the rotatable picture hanger may be magnetized by making the large disc 31 of the housing part 30 and the smaller disc 22 of the mounting part 20, or portions thereof, out of magnets. In some embodiments, the rotatable picture hanger may be magnetized by making the large disc 31 of the housing part 30 (or a part thereof) out of a magnet and the smaller disc 22 (or a part thereof) of the mounting part 20 out of metal, or vice versa.

In some embodiments, the rotatable picture hanger may be automated, e.g., by adding an engine or motor that can be controlled, e.g., wirelessly. In some embodiments, the engine may control the rotation of the mounting part 20, and with that the rotation of the picture. In some embodiments, a plurality of teeth or protrusions as described herein may be included and may conform with a gear-type system to facilitate rotation. In other embodiments, the mounting part 20 may be attached or connected to a shaft of a motor and may itself act as an extension of the shaft to facilitate rotation of the picture or object. This may eliminate the need to touch the picture. In some embodiments, the rotatable picture hanger may include a gyroscope or other sensor to detect the orientation of the picture or object, and may be configured to self-correct if necessary. For example, a video display on a moving or otherwise rotating object may be configured to constantly adjust and remain in a particular orientation (e.g., landscape) regardless of the orientation of the hanger. In some embodiments, the rotatable picture hanger may be controlled via software to provide other features, such as, for example, changing picture orientation once a day, at set intervals, or based on a triggering event.

In some embodiments, the rotatable picture hanger may include LED lights which may be embedded in or otherwise fastened to wall 36 of the housing section 30 or the cylinder 23 of mounting section 20. In some embodiments, these LED lights may illuminate the back of the picture to add a desired ambient feel. In some embodiments, the LED lights may eliminate the need for purchasing different lighting systems that can be messy and/or have wires which may take away from the overall esthetics of a room.

In some embodiments, a laser pointer, or an opening for a laser pointer, may be provided and/or integrated in the housing part 30 and/or mounting part 20, e.g., to facilitate accurate hanging.

In some embodiments, a method of manufacture of the rotatable picture hanger is provided. For example, in some embodiments, all or parts of the hanger may be manufactured using a 3D printer. A 3D model may be fully designed and ready to be printed, cured and act as a finished product, and/or may be customizable depending on the picture or object to be hung and/or the surface to which it is to be affixed. In some embodiments, the rotatable picture hanger, or parts thereof, may be formed using molds, e.g., creating and shaping the molds according to the 3D model. In some embodiments, the rotatable picture hanger or parts thereof may be formed using a CNC machine. For example, in some embodiments, each part 20 and 30 may be carved and shaped from blocks of materials such as plastics, marbles, woods, metals etc. In some embodiments, the rotatable picture hanger may be made by hand, e.g., cutting each part of the design and gluing or otherwise fastening the pieces together. As mentioned above, in some embodiments, the mounting part 20 is built from three primary shapes: one large disc 21, one smaller disc 22 and one connecting cylinder 23. In some embodiments, the housing part 30 is built from a large disc 31, a U-shaped front 32, and a wall 36 that connects between them to make a pocket 33.

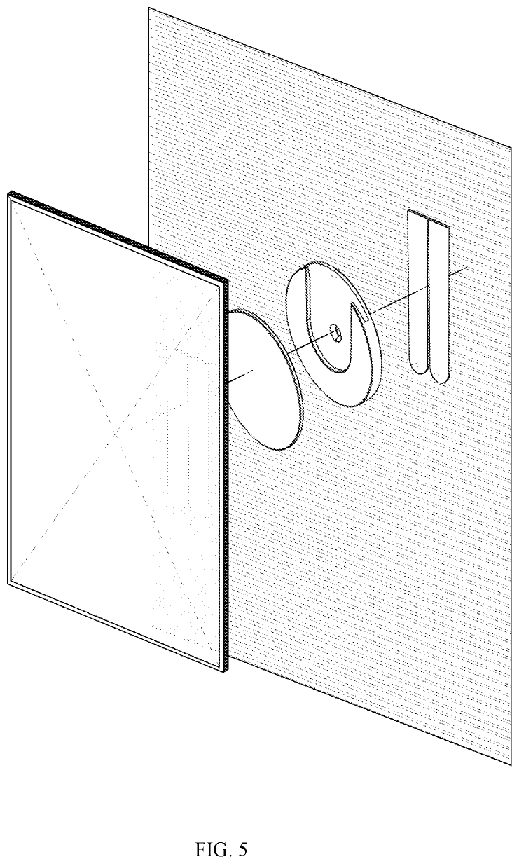

FIG. 5 is a perspective exploded view of the rotatable picture hanger along with stretch-releasable adhesive tapes, shown between a picture and a surface according to embodiments of the invention.

One skilled in the art will appreciate that the present invention can be practiced by other than the described embodiments, which are presented for purposes of illustration and not limitation. In addition, different embodiments are disclosed herein, and features of certain embodiments may be combined with features of other embodiments, such that certain embodiments maybe combinations of features of multiple embodiments. Further, since numerous modifications and changes will readily occur to those skilled in the art, it is not desired to limit the invention to the exact construction and operation shown and described, and accordingly, all suitable modifications and equivalents may be resorted to, without departing from the scope or spirit of the invention as defined in the appended claims.

What is claimed is:

1. A rotatable hanger device, comprising:
a mounting part, comprising:
a mounting front and a mounting back, each of the mounting front and the mounting back having a first side and a second side, the first side of the mounting back configured to be fastenable to a first surface and the second side of the mounting back positioned adjacent to the first side of the mounting front; and
a connecting arm, wherein the connecting arm is positioned between the mounting back and the mounting front, and connects the second side of the mounting back and the first side of the mounting front; and
a housing part comprising:
a housing front and a housing back, each of the housing front and the housing back having a first side and a second side, the first side of the housing back configured to be fastenable to a second surface and the second side of the housing back positioned adjacent to the first side of the housing front; wherein the housing front comprises a cut-out along an edge of the housing front; and
a wall connecting the housing back and the housing front;
wherein, the cut-out is sized and shaped relative to a size and shape of the connecting arm; and
wherein, the mounting part and the housing part are configured to interlock via insertion of a portion of the connecting arm into the cut-out such that at least part of the mounting front rests between the first side of the housing front and the second side of the housing back.

2. The device as in claim 1, wherein the first surface is a surface of a picture frame.

3. The device as in claim 1, wherein the first surface is a surface of an electronic device comprising a display.

4. The device as in claim 1, wherein the second surface is a wall.

5. The device as in claim 1, wherein the second surface is an interior surface of a vehicle.

6. The device as in claim 1, further comprising a mount-fastening means, wherein the first side of the mounting back is configured to be fastenable to the first surface by the mount-fastening means.

7. The device as in claim 1, further comprising a housing-fastening means, wherein the first side of the housing back is configured to be fastenable to the second surface by the housing-fastening means.

8. The device as in claim 1, wherein the connecting arm has a cylindrical cross-section and the cut-out has a corresponding u-shape.

9. The device as in claim 1, wherein the connecting arm has a polygonal cross-section and the cut-out has a corresponding polygonal shape.

10. A method of rotatably hanging an object on a surface, comprising:
providing a rotatable hanger device, the rotatable hanger device comprising:
a mounting part, comprising:
a mounting front and a mounting back, each of the mounting front and the mounting back having a first side and a second side, the first side of the mounting back configured to be fastenable to the object and the second side of the mounting back positioned adjacent to the first side of the mounting front; and
a connecting arm, wherein the connecting arm is positioned between the mounting back and the mounting front, and connects the second side of the mounting back and the first side of the mounting front; and
a housing part comprising:
a housing front and a housing back, each of the housing front and the housing back having a first side and a second side, the first side of the housing back configured to be fastenable to the surface and the second side of the housing back positioned adjacent to the first side of the housing front; wherein the housing front comprises a cut-out along an edge of the housing front; and
a wall connecting the housing back and the housing front;
wherein, the cut-out is sized and shaped relative to a size and shape of the connecting arm; and
wherein, the mounting part and the housing part are configured to interlock via insertion of a portion of the connecting arm into the cut-out such that at least part of the mounting front rests between the first side of the housing front and the second side of the housing back;
fastening the first side of the mounting back to the object;
fastening the first side of the housing back to the surface; and
interlocking the mounting part and the housing part.

11. The method as in claim 10, wherein the object is a picture frame.

12. The method as in claim 10, wherein the object is an electronic device comprising a display.

13. The method as in claim 10, wherein the surface is a wall.

14. The method as in claim 10, wherein the surface is an interior surface of a vehicle.

15. The method as in claim 10, wherein the rotatable hanging device further comprises a mount-fastening means, wherein the first side of the mounting back is configured to be fastenable to the object by the mount-fastening means.

16. The method as in claim 10, wherein the rotatable hanging device further comprises a housing-fastening means, wherein the first side of the housing back is configured to be fastenable to the surface by the housing-fastening means.

17. The method as in claim 10, wherein the connecting arm has a cylindrical cross-section and the cut-out has a corresponding u-shape.

18. The method as in claim 10, wherein the connecting arm has a polygonal cross-section and the cut-out has a corresponding polygonal shape.
